(19) United States
(12) Patent Application Publication
(10) Pub. No.: US 2010/0018040 A1
(43) Pub. Date: Jan. 28, 2010

(54) CRIMPING TOOL ADAPTER FOR ALIGNMENT AND INSTALLATION OF COAXIAL CABLE CONNECTOR NUT ROTATION AID

(76) Inventor: Edward Joseph BRADLEY, Livermore, CA (US)

Correspondence Address: DALINA LAW GROUP, P.C., 7910 IVANHOE AVE. #325, LA JOLLA, CA, 92037, US

(21) Appl. No.: 12/180,543

(22) Filed: Jul. 27, 2008

(51) Int. Cl. H01R 43/042; H01R 43/04

(52) U.S. Cl. 29/751; 29/862

(57) ABSTRACT

A crimping tool adapter for alignment and installation of coaxial cable connector nut rotation aid that enables a standard coaxial cable crimping tool to be augmented to allow a person to rapidly align a coaxial cable connector nut rotation aid in line with a coaxial cable connector and crimp the aid to the coaxial cable connector end i.e., the threaded nut while also crimping the coaxial cable connector to the coaxial cable. Adapter may be implemented as a plate with a radial portion having a central axis coincident with the axis of the conductor in the center of the coaxial cable. Plate is attached to the crimping tool, generally using existing screw holes on the crimping tool to augment the tool. Enables a coaxial cable connector nut rotation aid to be placed on the plate thereby properly aligning the coaxial cable connector nut rotation aid with the coaxial cable connector before crimping. May be made from any type of material, for example steel or plastic.

U.S. patent applicant Ser. No. 12/180,540 entitled “COAXIAL CABLE CONNECTOR NUT ROTATION AID” filed Jul. 27, 2008 is hereby incorporated herein by reference. U.S. patent applicant Ser. No. ______ entitled “COAXIAL CABLE DEBRAIDING AND COAXIAL CABLE CONNECTOR SEATING TOOL” filed Jul. 27, 2008 is hereby incorporated herein by reference.

### BACKGROUND OF THE INVENTION

1. Field of the Invention

Embodiments of the invention described herein pertain to the field of coaxial cables. More particularly, but not by way of limitation, one or more embodiments of the invention enable a crimping tool adapter for alignment and installation of a coaxial cable connector nut rotation aid that enables a standard coaxial cable crimping tool to be augmented to allow a person to rapidly align a coaxial cable connector nut rotation aid in line with a coaxial cable connector and couple the aid to the coaxial cable connector end, i.e., the threaded nut, while also crimping the coaxial cable connector to the coaxial cable wherein the coaxial cable connector nut rotation aid allows the person to attach or detach a coaxial cable connector to or from a coaxial cable port without requiring the use of a wrench for example.

2. Description of the Related Art

Coaxial cables are utilized for connecting high frequency components together. For example, coaxial cables may be utilized to connect antennas or cable boxes to televisions. Standard coaxial cables require the use of a wrench to rotate the threaded end extent, or nut, of the coaxial cable to attach the coaxial cable connector on, or off of, a coaxial cable port, for example on a cable set top box or DVD player. The wrench must be utilized in hard to reach areas and on components near electric sources. The use of a wrench is generally difficult in such areas.

Current apparatus exist that extend over the threaded nut of the coaxial connector, e.g., with a tight plastic tube fitting, to allow the cable to be hand tightened. The solutions provide for a torque aid that fixedly engages the nut and requires a torque aid per coaxial connector. Use of a crimping tool to engage the plastic tube fitting requires manual dexterity as the plastic tube must be properly aligned manually during the crimping and/or engaging process. As installers are generally required to couple large numbers of cables together, the extra time involved in properly aligning the plastic tube fitting becomes a significant cost when multiplied by the large number of connectors that must be prepared.

For at least the limitations described above there is a need for a crimping tool adapter for coaxial cable connector nut rotation aid alignment.

### BRIEF SUMMARY OF THE INVENTION

One or more embodiments of the invention enable a crimping tool adapter for alignment and installation of coaxial cable connector nut rotation aid that enables a standard coaxial cable crimping tool to be augmented to allow a person to rapidly align a coaxial cable connector nut rotation aid in line with a coaxial cable connector and couple the aid to the coaxial cable connector end, i.e., the threaded nut, while also crimping the coaxial cable connector to the coaxial cable wherein the coaxial cable connector nut rotation aid allows the person to attach or detach a coaxial cable connector to or from a coaxial cable port without requiring the use of a wrench for example.

One or more embodiments of the invention provide a plate that includes an alignment element having a central axis coincident with the axis of the conductor in the center of the coaxial cable. In one or more embodiments of the invention, the alignment element may include a groove with an arc shaped or circular cross-section, a v-shaped groove, or a groove that includes a polygon cross-section or a groove that includes a conical section or any part thereof. Any structural elements or formation within the elements such as one or more finger elements or any other structure that is configured to align the coaxial cable connector nut rotation aid coincident with the longitudinal axis of the coaxial cable are in keeping with the spirit of the invention. In this manner, the plate is attached to the crimping tool, generally using existing screw holes or any other type of clamping mechanism on the crimping tool, to augment the tool. By augmenting the tool with the plate, a coaxial cable connector nut rotation aid may be placed on the plate, thereby properly aligning the coaxial cable connector nut rotation aid with the coaxial cable connector before crimping the coaxial cable connector to the coaxial cable or engaging the coaxial cable connector nut rotation aid with the coaxial cable connector nut. Embodiments of the invention may be made from any type of material, for example steel or plastic.

### BRIEF DESCRIPTION OF THE DRAWINGS

The above and other aspects, features and advantages of the invention will be more apparent from the following more particular description thereof, presented in conjunction with the following drawings wherein:

FIG. 1 shows four embodiments of the coaxial cable connector nut rotation aid.

FIG. 2 shows a coaxial cable connector crimping tool with an embodiment of the invention coupled therewith.

FIG. 3 shows a close-up of the reverse side of the crimping tool and embodiment of the invention attached to the crimping tool using existing screw holes.

FIG. 4 illustrates the various stages of coupling a coaxial cable rotation aid to a coaxial cable.

FIGS. 5A and 5B present cross-sectional views of a coaxial cable connector rotational aid with one embodiment of the invention.

FIGS. 6A-6D present views of one or more embodiments of the invention.

### DETAILED DESCRIPTION

A crimping tool adapter for alignment and installation of coaxial cable connector nut rotation aid will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that, although examples of the invention are set forth herein, the claims, and the full scope of any equivalents, are what define the metes and bounds of the invention.

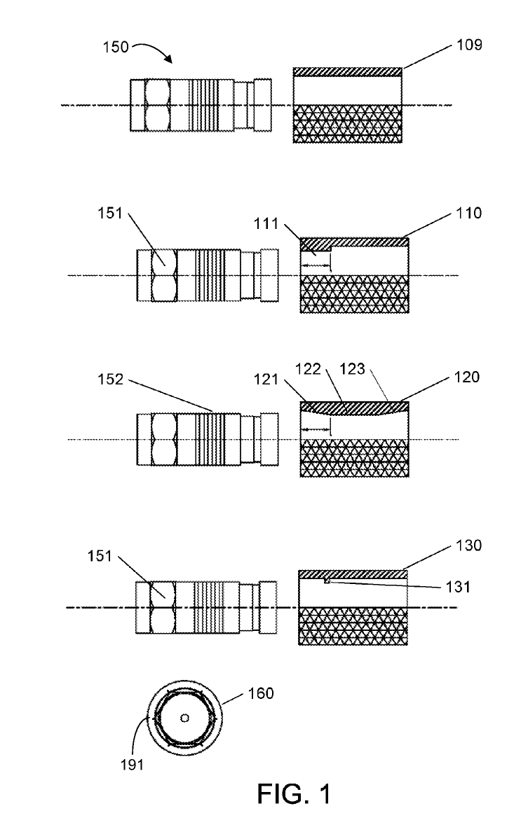

FIG. 1 shows four embodiments of a coaxial cable connector nut rotation aid that may be utilized with embodiments of the invention. Any other type of coaxial cable connector nut rotation aid that is configured for crimping may be utilized with embodiments of the invention that are sized based upon the outer diameter of the desired aid in order to bring the longitudinal axis of the tubular aid in alignment with which the coaxial cable connector couples. Aid 109 is a hollow cylinder with an internal diameter dimension large enough to accommodate an “F type” coaxial connector. In this case, the inner diameter dimension is 12.45 mm. Through use of a soft metal for aid 109, crimping aid 109 onto coaxial cable connector 150 is performed with minimal effort. Aid 110 includes a narrower inner portion 111 to provide a tighter fit with nut 151 for example. Aid 120 provides a 6.5 mm deep ramp 121 into aid 120, wherein the innermost area 122 is large enough to accommodate collar 152, while opposing side ramp 123 allows for non-rotatable coupling with the opposing coaxial cable connector on the opposing side of the cable. Aid 130 provides stop 131 to provide a limit to the depth at which nut 151 can be displaced into aid 130. Other aids, such as plastic aids, may also be utilized with embodiments of the invention and in so doing lowers the time and increases the quality of the resulting crimped combination. While specific dimensions and geometries are described above, coaxial cable connector nut rotation aids with differing dimensions or geometries that may be utilized with embodiments of the invention are in keeping with the spirit of the invention.

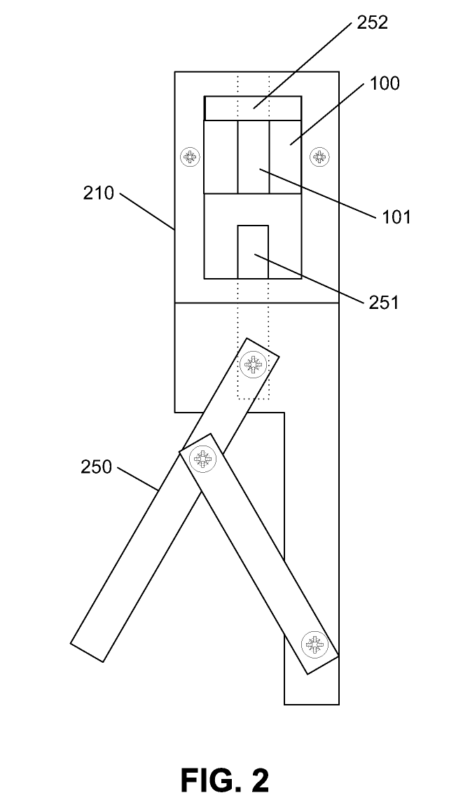

FIG. 2 shows coaxial cable connector crimping tool 210 with an embodiment of the invention, e.g., plate 100, coupled therewith. Plate 100 is shown with alignment groove 101 with a configured depth away from the axis defined between ram 251 and stop 252. The configured depth of alignment groove 101 is set in this embodiment to coincide with the thickness of the tool to the plate and to match the outer diameter of the embodiments shown in FIG. 1, for example 15.82 mm. Any other outer diameter aid dimension may be accommodated by providing a deeper or shallower groove 101 to bring the central axis of the aid in line with the axis between ram 251 and stop 252 for example. Operation of handle 250 inwardly applies a force that is parallel with the axis of coaxial cable connector nut rotation aid 109 pushes ram 251 towards stop 252 and crimps the coaxial cable connector to the coaxial cable and simultaneously couples the coaxial cable connector nut rotation aid to the nut at the end of the coaxial connector. As the coaxial cable connector nut rotation aid 109 is forced over nut 151, grooves are carved into inner surface of coaxial cable connector nut rotation aid 109 to create a non-fixed, non-rotatable coupling with respect to nut 151.

In one or more embodiments of the invention, activation of the crimping tool may only engage the coaxial cable connector nut rotation aid to the nut of the coaxial connector. In other embodiments of the invention, the activation of the crimping tool may only crimp the coaxial cable connector to the coaxial cable. In other embodiments, the activation of the crimping tool may engage the coaxial cable connector nut rotation aid to the nut and also crimp the coaxial cable connector onto the coaxial cable in one action for example.

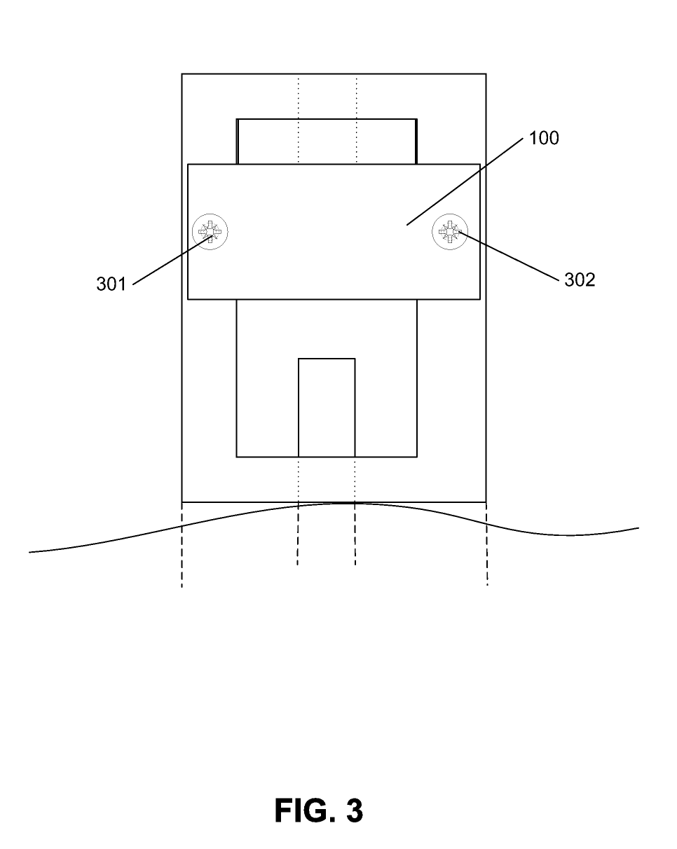

FIG. 3 shows a close-up of the reverse side of the crimping tool and embodiment of the invention, i.e., plate 100, attached to the crimping tool using existing screw holes in the crimping tool, generally located to couple stop 252 to the remaining portion of the crimping tool. Screws 302 and 302 are utilized with the existing screw holes in the crimping tool to couple plate 100 to the crimping tool. Slotted holes in plate 100 may be utilized to cover multiple crimping tools from alternate manufacturers for example. In one or more embodiments of the invention, the holes or the slotted holes may be formed using a drill, or by using a router, or with a milling tool, or with a Computer Numerical Control (CNC) machine for example. In one or more embodiments of the invention, other forms of attaching plate 100 to crimping tools may employ mechanical fasteners, clamps, multiple holes, multiple pins, or any other method of coupling plate 100 to the crimping tool. Embodiments of the invention may be constructed from any durable material including but not limited to metal and plastic so long as the axis of the coaxial cable connector nut rotation aid is maintained in axial alignment with the coaxial cable connector during the crimping process. Examples of material which may be employed in one or more embodiments of the invention include fiberglass, carbon fiber, metal, or plastic or any other material or shape that can maintain axial alignment of the coaxial cable connector nut rotation aid with the coaxial cable connector. In one or more embodiments of the invention, the plate is formed through an extrusion process, through a machining or milling process, through the use of a CNC machine, or through the use of an injection molding apparatus for example.

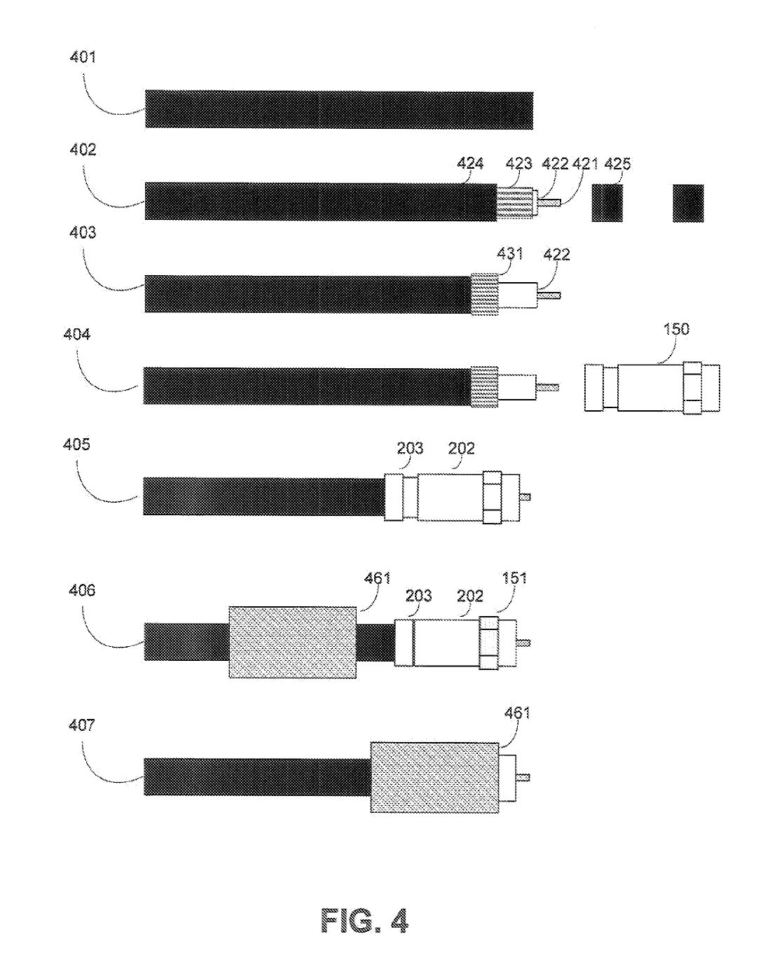

FIG. 4 is an illustration of the various stages of coupling a coaxial cable rotation aid to a coaxial cable. Coaxial cable 401 is shown with an unprepared left hand end that is not square, while the right hand side of coaxial cable 401 is shown in a prepared state having a clean cut end that is perpendicular to the axis along coaxial cable 401. Stripped coaxial cable 402 is shown as stripped with a ¼ inch by ¼ inch stripping tool. As shown, outer insulating jacket 424, shield braiding 423 and dielectric 422 are cut away on the far right, thereby leaving conductor 421 exposed. In addition, the stripping tool also cuts outer insulating jacket 424 down to shield braiding 423, which is also shown removed as removed outer shield braiding 425. The shield braiding is shown folded back at 431 away from dielectric 422 on prepared coaxial cable 403 in preparation for coupling coaxial cable connector 150, which is placed in line with correctly aligned and prepared coaxial cable 404. Coaxial cable connector 150 is seated on fully prepared coaxial cable 405 wherein dielectric 422 is fully pressed into post 201 until it travels no further and in so doing sleeve 203 and collar 202 are in axial alignment and are ready for compression. A crimping tool is utilized to compress coaxial cable connector 150 to yield fully coupled coaxial cable 406 wherein sleeve 203 and collar 202 are fully engaged, therein fixedly attaching sleeve 203 and collar 202 to the coaxial cable. Coaxial cable connector nut rotation aid 461 is placed onto the bare end, i.e., opposing end of fully coupled coaxial cable 406, and slid over the nut with the crimping tool to embed grooves to non-fixedly and non-rotatably attached the aid onto nut 151 thereby producing coaxial cable connector rotational aid end 407. By preparing and coupling another coaxial cable connector to the opposing (left side as shown) of end 407, coaxial cable connector nut rotation aid 461 may be coupled to the opposing end coaxial cable connector nut by sliding coaxial cable connector nut rotation aid 461 off of nut 151 manually and moving coaxial cable connector nut rotation aid to the opposing end and using the crimping tool to embed grooves on the opposite side of coaxial cable connector nut rotation aid 461. The grooves carved into each side of coaxial cable connector nut rotation aid 461 allow for a non-fixedly non-rotatably coupling with respect to nut 151 and a rotational coupling with respect to outer insulating jacket 424.

The sequencing and the specific steps of preparing the coaxial cable, coaxial connector, and the coaxial connection rotation aid described above are given only as an example. One or more embodiments of the invention may have differing preparation sequencing or processing steps. All sequence and processing steps that prepare the components for final assembly are in keeping with the spirit of the invention.

Embodiments of the invention allow for skipping of the independent crimping of the coaxial cable connector shown at 406 before embedding grooves in the coaxial cable connector nut rotation aid end 407. For example, by placing the un-crimped coaxial connector, i.e., fully prepared coaxial cable 405 in conjunction with coaxial cable connector nut rotation aid 461 into crimping tool 110 fitted with plate 100, one action may be performed instead of two actions. The single action couples both the coaxial cable connector to the cable by crimping the connector and embedding grooves in coaxial cable connector nut rotation aid 461 to the coaxial cable connector nut in one step. Likewise, in one or more embodiments of the invention may allow for only crimping of the coaxial cable connector 202 to the coaxial cable without engaging or coupling the coaxial cable connector nut rotation aid 461 to the nut 151. In one or more embodiments of the invention may allow for only coupling the coaxial cable connector nut rotation aid 461 to the nut 151 without coupling the coaxial cable connector 202 to the coaxial cable.

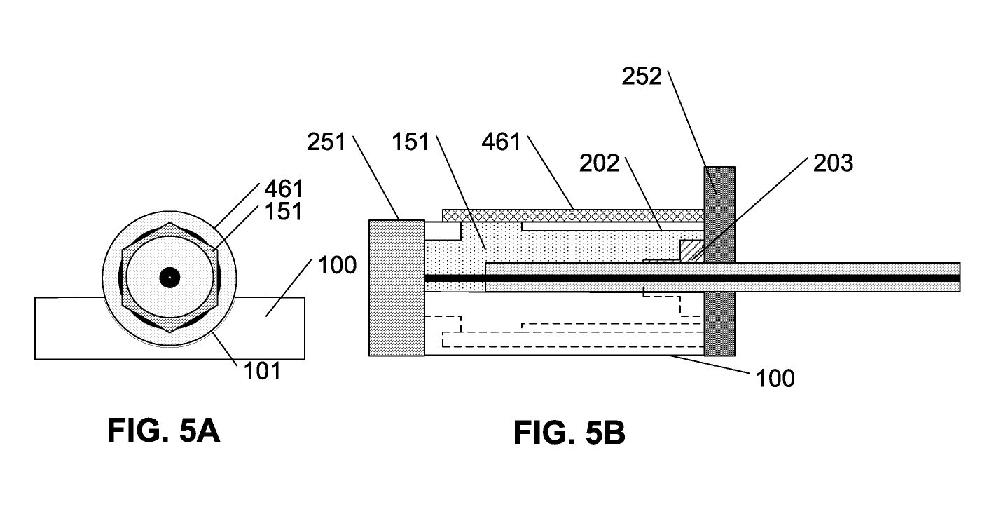

FIG. 5A and 5B present cross-sectional views of a coaxial cable connector nut rotation aid resting upon an embodiment of the invention, i.e., plate 100 within the crimping tool 250. FIG. 5B presents the cross-sectional view of the crimping tool 210 and depicts the relative alignment of the nut 151, the coaxial rotation aid 461, the sleeve 202, collar 202, and the ram 251 and stop 203 after the ram 251 pushes sleeve 202 onto collar 203 and simultaneously pushes, or engages coaxial rotation aid 461 onto the nut 151. FIG. 5A depicts one or more embodiments in which a groove having an arc or circular cross-section is employed. In one or more embodiments of the invention, a groove having an arc or circular cross section may be formed through the use of a milling or machining process employing a CNC machine, an extrusion process, a saw, or a router, for example, or may be formed using a mold and an injection molding machine for example. In one or more embodiments of the invention, the shape of the arc or cross section is determined based on the geometry of the crimping tool and the diameter of the coaxial cable connector nut rotation aid. As depicted in FIG. 5B, the configured depth of alignment groove 101 is set in this embodiment to coincide with the thickness of the tool to the plate and to match the outer diameter of coaxial cable connector nut rotation aid 461. The depth of the groove 101 is such that the central axis of the coaxial rotation aid 561 is in line with the axis between ram 251 and stop 252 for example. Embodiments of the invention can be resized for mini-coax, RG-6, RG-11, RG 58, RG-58c, RG-59 or any other coaxial cable type by resizing the plate and or groove to maintain the proper offset that provides correct central axial alignment of coaxial cable connector nut rotation aid 461 with the coaxial cable connector.

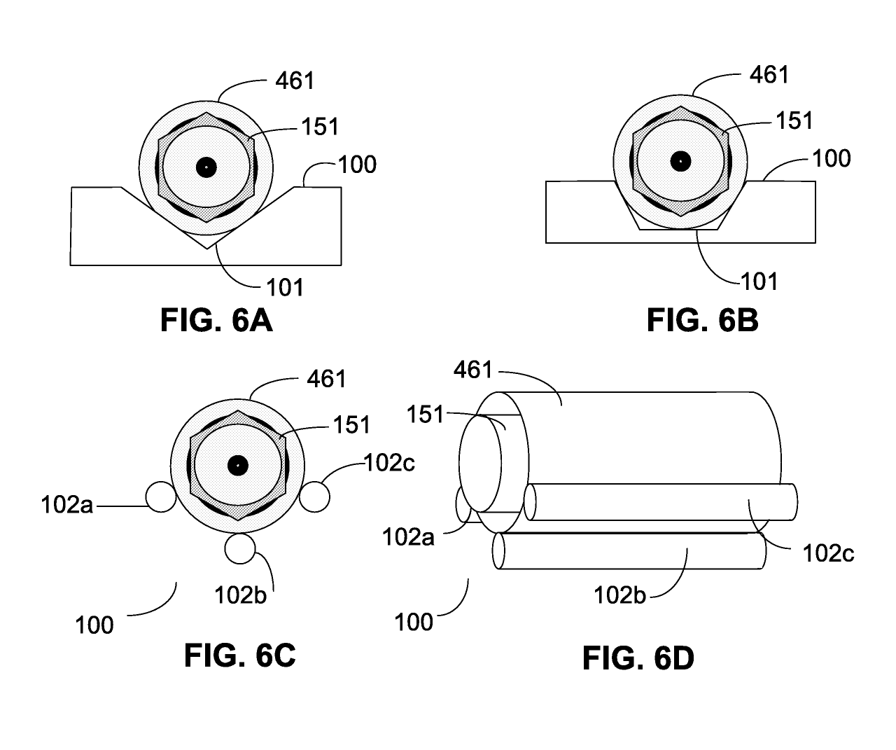

FIGS. 6A-6D depict other embodiments of the invention. One or more embodiments of the invention provide a plate 100 having an alignment element having a central axis coincident with the axis of the conductor in the center of the coaxial cable. As depicted in FIGS. 6A and 6B, in one or more embodiments of the invention, the alignment element may include a groove with an arc shaped or circular cross-section, a v-shaped groove, or a groove having a polygon cross-section or a groove that includes a conical section or any part thereof. In one or more embodiments of the invention, a groove having a v-shaped or polygon cross-section may be formed through the use of a milling or machining process employing a CNC machine, a saw, or a router for example, or may be formed using a mold and an injection molding machine for example. In one or more embodiments of the invention, the shape of v-shape or polygon is determined based on the geometry of the crimping tool and the diameter of the coaxial cable connector nut rotation aid. FIG. 6C depicts a cross-sectional view of one or more embodiments of the invention having multiple finger elements 102a, 102b, and 102c to support and align the coaxial cable connector nut rotation aid. In one or more embodiments of the invention, the multiple finger elements could be formed through a machining or milling process using a CNC machine, a saw, a lathe for example or by an injection molding process for example. In one or more embodiments of the invention, the placement of the finger elements is determined based on the geometry of the crimping tool and the diameter of the coaxial cable connector nut rotation aid. Any structural elements or formation within the elements that align the coaxial cable connector nut rotation aid with the central axis of the conductor in the center of the coaxial cable are in keeping with the spirit of the invention.

While the invention herein disclosed has been described by means of specific embodiments and applications thereof, numerous modifications and variations could be made thereto by those skilled in the art without departing from the scope of the invention set forth in the claims.

What is claimed is:

1. A crimping tool adapter apparatus for alignment and installation of coaxial cable connector nut rotation aid comprising:
a plate;
said plate configured with a longitudinal alignment element having a central axis point coincident with an axis defined by a coaxial cable connector placed by a ram and a stop of a crimping tool; and,
said plate configured to couple with said crimping tool and configured to support a coaxial cable connector nut rotation aid in alignment with said axis.

2. The crimping tool adapter apparatus of claim 1 wherein said longitudinal alignment element comprises a longitudinal groove that comprises an arc-shaped cross-section.

3. The crimping tool adapter apparatus of claim 1 wherein said longitudinal alignment element comprises a V-shaped groove.

4. The crimping tool adapter apparatus of claim 1 wherein said longitudinal alignment element comprises a groove wherein cross-section of said groove comprises a polygon.

5. The crimping tool adapter apparatus of claim 1 wherein said longitudinal alignment element comprises at least one longitudinal finger element.

6. The crimping tool adapter apparatus of claim 1 wherein said plate comprises at least one slotted hole.

7. A method for adapting a crimping tool for alignment and installation of coaxial cable connector nut rotation aid comprising:
forming a plate having a longitudinal alignment element having a central axis point coincident with an axis defined by a ram and a stop of a crimping tool; and,
coupling said plate to a crimping tool.

8. The method of claim 7 wherein said forming said plate further comprises forming a longitudinal groove in said longitudinal alignment element wherein said longitudinal groove comprises an arc-shaped cross-section.

9. The method of claim 7 wherein said forming said plate comprises extruding said plate.

10. The method of claim 7 wherein said forming said plate further comprises forming a V-shaped groove in said longitudinal alignment element.

11. The method of claim 7 wherein said forming said plate further comprises forming a polygon groove in said longitudinal alignment element.

12. The method of claim 7 wherein said forming said plate further comprises forming at least one longitudinal finger element in said longitudinal alignment element.

13. The method of claim 7 wherein said forming said plate further comprises forming at least one slotted hole in said plate.

14. A crimping tool adapter apparatus for alignment and installation of coaxial cable connector nut rotation aid comprising comprising:
means for forming a plate having a longitudinal alignment element having a central axis point coincident with an axis defined by a ram and a stop of a crimping tool; and,
means for coupling said plate to a crimping tool.

15. The apparatus of claim 14 wherein said means for forming said plate further comprises means for forming a longitudinal groove in said longitudinal alignment element wherein said longitudinal groove comprises an arc-shaped cross-section.

16. The apparatus of claim 14 wherein said means for forming said plate comprises means for extruding said plate.

17. The apparatus of claim 14 wherein said means for forming said plate further comprises means for forming a V-shaped groove in said longitudinal alignment element.

18. The apparatus of claim 14 wherein said means for forming said plate further comprises means for forming a polygon groove in said longitudinal alignment element.

19. The apparatus of claim 14 wherein said means for forming said plate further comprises means for forming at least one longitudinal finger element in said longitudinal alignment element.

20. The apparatus of claim 14 wherein said means for forming said plate further comprises means for forming at least one slotted hole in said plate.
